(19) United States
(12) Patent Application Publication
(10) Pub. No.: US 2023/0247431 A1
(43) Pub. Date: Aug. 3, 2023

(54) METHODS, DEVICES AND SYSTEMS FOR PREVENTING TRACKING BY USE OF REPLY ATTACKS

(71) Applicant: Cypress Semiconductor Corporation, San Jose, CA (US)

(72) Inventor: Hui LUO, Marlboro, NJ (US)

(73) Assignee: Cypress Semiconductor Corporation, San Jose, CA (US)

(21) Appl. No.: 17/590,728

(22) Filed: Feb. 1, 2022

(51) Int. Cl. H04W 12/122; H04W 12/037; H04W 12/0431; H04L 9/32

(52) U.S. Cl. CPC H04W 12/122; H04W 12/037; H04W 12/0431; H04L 9/3239

(57) ABSTRACT

A method can include establishing a wireless encrypted connection; establishing a long term encryption key (LTK) and an anti-tracking (A-T) count value for a peer device; storing the LTK and A-T count value in a nonvolatile memory circuit; receiving a communication that includes an identity value corresponding to the peer device and a peer hashed anti-tracking count (HATC); generating at least one local HATC by executing a predetermined hash function on at least the LTK and a changed A-T count value that varies from the stored A-T count value by a predetermined amount. The received peer HATC can be authenticated with the at least one local HATC. In response to the peer HATC being authenticated, communications can occur with the peer device. In response to the peer HATC not being authenticated, communications may not occur with the peer device. Related devices and systems are also disclosed.

### TECHNICAL FIELD

The present disclosure relates generally to wireless devices that include secure identity keys for identifying peers, and more particularly to preventing tracking of such wireless devices through the use of replay attacks.

### BACKGROUND

Devices operating according to a Bluetooth (BT) standard can use resolvable private addresses (RPAs) to identify peer devices. BT devices can pair with another, exchange security information, and after establishing an encrypted connection with temporary keys, bond with one another. Bonding can include the exchange long term values, including long term encryption keys (LTKs) and identity resolving keys (IRK). Once bonded, BT devices can establish an encrypted connection without having to exchange security information by identifying one another by using RPAs. FIG. 12A shows an RPA. An RPA can include a 24-bit hash value and a 22-bit randomized value (prand), and two fixed bits “1” and “0”. The hash value can be generated by hashing with the IRK and the prand value. In this way, BT devices receiving requests from an apparent peer, can hash a prand included in the message with stored IRKs to resolve the address and thus identify the peer.

A drawback to conventional operations is that it is possible to use replay attacks to detect and track a device. FIGS. 12B-0 and 12B-1 show conventional operations of BT systems, including responses to a replay attack. FIG. 12B-0 shows a system 1251 at a first location. A first location can include a BT peripheral device 1255 that has previously bonded with a BT central device 1253. Peripheral device 1255 can issue an advertisement 1259 (shown by \textcircled{1}). Because the central device 1253 and peripheral device 1255 were previously bonded, advertisement can include an RPA generated with an IRK that is known by the central device 1253. Upon receiving the advertisement 1259, central device 1253 can resolve the RPA to confirm the identity of the peripheral device, and generate a response 1263 (shown by \textcircled{2}). However, a snooping device 1257 at the same location can detect the advertisement 1259 and record its content, including the RPA 1261.

FIG. 12B-1 shows a system 1265 at a second location. While central device 1253 is at the second location, a phishing device 1257′ can emit a replay message 1259R that includes the RPA 1261. In response, central device 1253 can resolve the address and issue a response 1263′. From such a response, the central device 1253 can be tracked at the second location, particularly if the central device 1253 is the only other device at the second location.

Other conventional systems can suffer from the same or similar drawbacks noted in FIGS. 12A to 12B-1. For example, a neighbor-aware-network (NAN) can use identity tags to authenticate devices that have previously exchanged or derived identity keys. In particular, a WiFi Aware network can operate with NAN identity resolution (NIR) values. NIR values can include an NIR tag generated as follows:

NIR Tag=Truncate-64(HMAC-SHA-256(NIK, “NIR”, NMI∥Nonce∥counter),

where Truncate-64 is a 64-bit truncation operation, HMAC-SHA-256 is a hash function, NIK is a NAN identity key previously established in a pairing setup operation, NMI is a NAN management interface address, Nonce is a nonce value, and counter is a counter value.

FIG. 13A shows operations of a NAN system 1351 at a first location. A first location can include a subscriber device 1355 that has previously executed a pairing setup operation with a publisher device 1353.

Subscriber device 1355 can issue a subscriber message 1367 with an NIR tag (NIR_s). Publisher device 1353 can resolve NIR_s using a stored NIK for the subscriber device. Similarly, publisher device 1353 can issue a publisher message 1359 with its own NIR tag (NIR_p 1361). Subscriber device 1355 can resolve NIR_p 1361 using a stored NIK from the publisher device. In this way, a subscriber device 1355 can discover a service instance of the publisher device 1353 and the two devices can be established as being paired 1369.

Once subscriber device 1355 establishes that it is paired with publisher device 1353, it can start a pairing verification operation 1373. Pairing verification can include the exchange of messages in a pre-association security negotiation (PASN), including a first PASN message 1375. When pairing verification ends, subscriber device 1355 and publisher device 1353 can setup an encrypted data path for communication.

Referring still to FIG. 13A, a snooping device 1357 can be at the first location, and can record publisher message 1359, including NIR_p 1361.

FIG. 13B shows a system 1365 at a second location. While a subscriber device 1355 is at the second location, a phishing device 1357′ can emit a replay message 1359R that includes the NIR_p 1361. In response, subscriber device 1355 can resolve the NIR tag 1361 and determine the phishing device is a paired device 1369′. Subscriber device 1355 can then start a pairing verification operation 1373′. This can include the subscriber device 1355 issuing a first PASN message 1375′. From such a message, the subscriber device 1355 can be tracked 1379 at the second location, particularly if subscriber device 1355 is the only other device at the second location.

It would be desirable to arrive at some way addressing the tracking vulnerabilities of wireless systems described herein.

### SUMMARY

Embodiments can include a method that establishes a wireless encrypted connection; establishes a long term encryption key (LTK) and an anti-tracking (A-T) count value for a peer device; stores the LTK and A-T count value in a nonvolatile memory circuit; receives a communication that includes an identity value corresponding to the peer device and includes a peer hashed anti-tracking counter (HATC). At least one local HATC can be generated by executing a predetermined hash function on at least the LTK and a changed A-T count value. A changed A-T count value can vary from the stored A-T count value by a predetermined amount. The received peer HATC can be authenticated with at least one local HATC. In response to the peer HATC being authenticated, communications can occur with the peer device. In response to the peer HATC not being authenticated, no communications are made with the peer device.

### BRIEF DESCRIPTION OF THE DRAWINGS

FIG. 1A is a flow diagram of a method for a responding device according to an embodiment. FIG. 1B shows enhanced privacy values that can be stored by a device according to an embodiment.

FIG. 2 is a flow diagram of a method for a requesting device according to an embodiment.

FIG. 3 is a diagram showing a system and operations for Bluetooth (BT) devices according to an embodiment.

FIG. 4A is a diagram showing a set up operation for neighbor-aware-network (NAN) devices according to an embodiment. FIG. 4B is a diagram showing a verification operation for NAN devices according to an embodiment.

FIG. 5 is a block diagram of a device having enhanced privacy according to an embodiment.

FIG. 6A is a block diagram of a BT device having enhanced privacy according to an embodiment. FIG. 6B is a diagram showing BT packet according to an embodiment.

FIG. 7A is a block diagram of a NAN device having enhanced privacy according to an embodiment. FIG. 7B is a diagram showing a NAN packet according to an embodiment.

FIG. 8 is a diagram of a device according to an embodiment.

FIG. 9 is a block diagram of system according to an embodiment.

FIG. 10 is a diagram of system according to another embodiment.

FIG. 11 is a diagram of a system according to a further embodiment.

FIGS. 12A to 12B-1 are diagrams showing conventional BT devices and responses.

FIGS. 13A and 13B are diagrams showing conventional NAN devices and responses.

### DETAILED DESCRIPTION

Embodiments can provide enhanced privacy in wireless systems in which devices communicate directly with one another over encrypted connections. Devices can establish initial encrypted connections and exchange protected data, which can include long term encryption keys (LTKs) as well as an anti-tracking (A-T) count value. When a communication is received from what appears to be a peer device, it can be authenticated with a hashed anti-tracking count (HATC). An HATC can be generated with a hash function operating on at least the LTK and a changed (e.g., incremented) A-T count value. In some embodiments, a nonce and another count value (i.e., not an A-T count value) can be included in the hashing operation. If authentication of the HATC fails, communications can end, preventing replay attacks from generating a response. If the HATC is authenticated, the two devices can re-establish the encrypted connection without having to exchange protected data again. In some embodiments, enhanced privacy can be provided in a Bluetooth (BT), network (e.g., piconet), including BT Low Energy (BLE) networks.

In some embodiments, enhanced privacy can be provided in a neighbor-aware-network (NAN), such as a WiFi Aware network.

In some embodiments, a received HATC can be authenticated against multiple local HATCs, where the local HATCs are generated with different changed A-T count values. In some embodiments, one local HATC can be generated with an A-T count incremented by a first amount (e.g., +1), while another HATC can be generated with an A-T count incremented by a second amount (e.g., +2).

In some embodiments, once an encrypted connection has been established, an A-T count can be updated (e.g., incremented). This can include updating the A-T count based on which local HATC authenticated a received HATC.

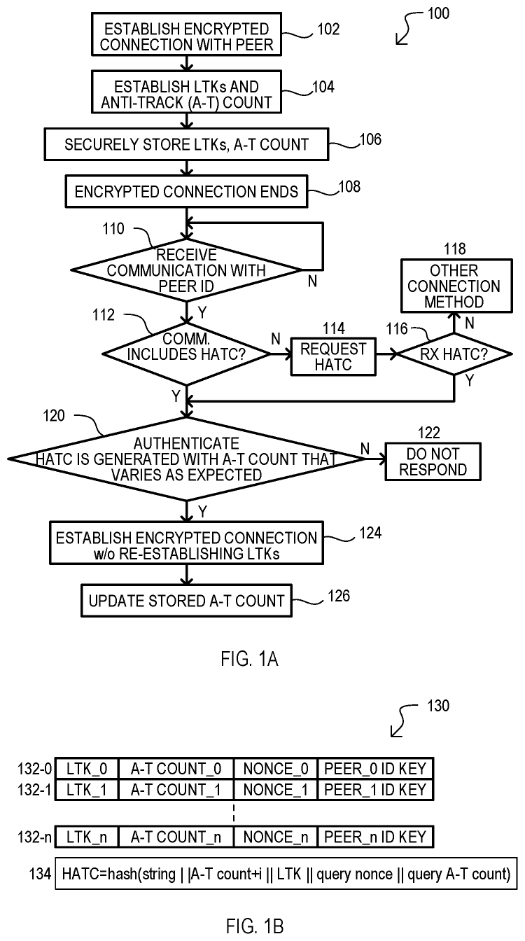

FIG. 1 is a flow diagram of a method 100 according to an embodiment. A method 100 can be executed by a “responding” device that “bonds” with a “requesting” device. A method 100 can include establishing an encrypted connection with a peer 102. Such an action can include executing a connection procedure according to a predetermined protocol. Such a protocol can include a publicly known standard, or can include a proprietary standard. Such an action can include establishing security values, including long term keys (LTKs) and an A-T count. Establishing such values can include an exchange of values and/or the generation of such values based on agreed upon methods. An encrypted connection can follow any suitable encryption method, including the use of public keys, private keys and combinations thereof. LTKs can be keys used for encryption and decryption of communications. An A-T count can be a value essentially shared between the two devices. An A-T count can be updated each time encrypted communications are re-established between the two devices.

A method 100 can include securely storing LTKs and A-T count values. Such an action can include storing such values in a secure nonvolatile memory. The encrypted connection can end 108. Such an action can include either device ending the connection, or some condition causing the connection to be ended.

A method 100 can determine if a communication has been received with a peer ID 110. In some embodiments, such an action can include determining if a received packet includes a field identifying it as being transmitted from a known peer.

In some embodiments, this can include “resolving” and address or identification value with an identity key for the peer device. Such a resolving operation can include performing a hash operation on a received value with identity keys, and comparing the resulting hash values with a received hash value. If a communication is received that includes a peer identification (ID) value 110, a method 100 can determine if the communication includes a hashed anti-tracking count (HATC) 112. Such an action can include determining the type of communication received. In some embodiment, a peer device can send a transmission that includes one or multiple HATCs (e.g., an advertisement). If a communication that appears from a peer does not include an HATC (N from 112), an HATC can be requested from the peer device 114. Such an action can include transmitting a packet that identifies the peer (e.g., an address) and includes a field indicating the request for an HATC. If an HATC is not received in response to a request (N from 116), a method 100 can attempt another connection method 118, or in some embodiments, may end communications.

If a communication received from the peer includes an HATC (Y from 112) or a requested HATC has been received (Y from 116), a method 100 can authenticate the HATC with an A-T count the varies as expected 120. In some embodiments, such an action can include generating a hash value with a hash function that operates on a changed A-T count value. A changed A-T count value can be the stored A-T count value changed in a predetermined manner (e.g., incremented and/or decremented). Such an authentication operation can include comparing a received HATC to multiple locally generated HATCs.

If authentication succeeds (Y from 120), a method 100 can establish an encrypted connection without the need to re-establish encryption keys 124. Such an action can enable relative rapid reconnection with bonded peers. A stored A-T count can be updated 126. Such an action can include changing a stored A-T count in a predetermined manner (e.g., incrementing, decrementing).

If authentication fails (N from 120), a method 100 can make no response 122 (e.g., end communications). In this way, a method 100 can provide enhanced privacy, as a device cannot be detected and/or tracked by eliciting a response with a communication using a previous peer ID value (e.g., a replay attack). This is in contrast to conventional approaches in which a device can respond to communications that include an ID value corresponding to a previously bonded peer.

FIG. 1B is a diagram showing enhanced privacy values 130 of a wireless device according to an embodiment. Such enhanced privacy values 130 can be stored in a secure memory of a device. Enhanced privacy values 130 can include a number of peer enhanced entries 132-0 to -n. Each peer entry (132-0 to -n) can correspond to a different peer device. Peer entries (132-0 to -n) can include a long term key (LTK_x), an A-T count (A-T COUNT_x), a nonce value (NONCE_x) and a peer ID key (PEER_x ID KEY), where x corresponds to an entry.

FIG. 1B also shows an HATC 134 according to an embodiment. An HATC can be generated for a peer device using entry values (132-0 to -n) for the peer device. HATC can be generated with a hash function operating on a string value, a changed A-T count value (A-T count+i), a long term key, a nonce value corresponding to the peer, and the A-T count value corresponding to the peer.

In this way, a device can securely store peer values to authenticate communications with an anti-tracking value that varies with each subsequent connection. This can enable replay attacks to be ignored, thus providing enhanced privacy.

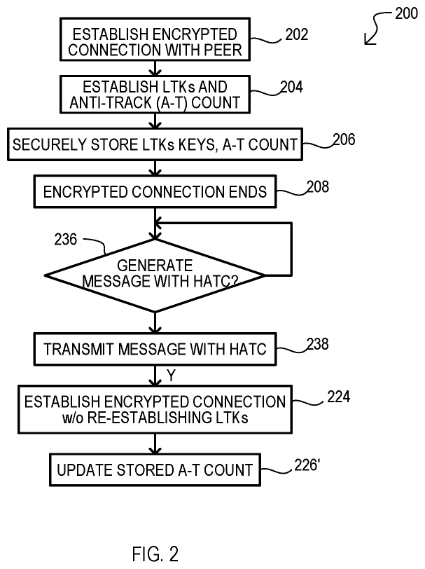

FIG. 2 is a flow diagram of a method 200 according to an embodiment. A method 200 can be executed by a requesting device that issues a request to a responding device to re-establish a connection without having to exchange security information. A method 200 can include actions like those described for FIG. 1A, including establishing an encrypted connection with a peer 202, establishing LTKs and A-T counts 204, and securely storing the LTKs and A-T counts 206. The encrypted connection can end 208. Such an action can include any of those described herein and equivalents.

A method 200 can determine whether or not to generate a message that includes an HATC 236. How such an action occurs can depend upon the protocol used and/or mode of operation. In some embodiments, a message with an HATC can be periodically generated in a communication (e.g., advertisement). In some embodiments, a message with an HATC can be generated in response to a request for an HATC.

A method 200 can transmit a message with an HATC 238. Such an action can include generating an HATC by hashing multiple values, one of which is a stored A-T count altered in a predetermined manner (e.g., incremented or decremented).

A method 200 can establish an encrypted connection without the need to re-establish encryption keys 224. As noted, such an action can enable relative rapid reconnection with bonded peers. A stored A-T count can be updated 226′. Such an action can include changing a stored A-T count in a predetermined manner (e.g., incrementing, decrementing).

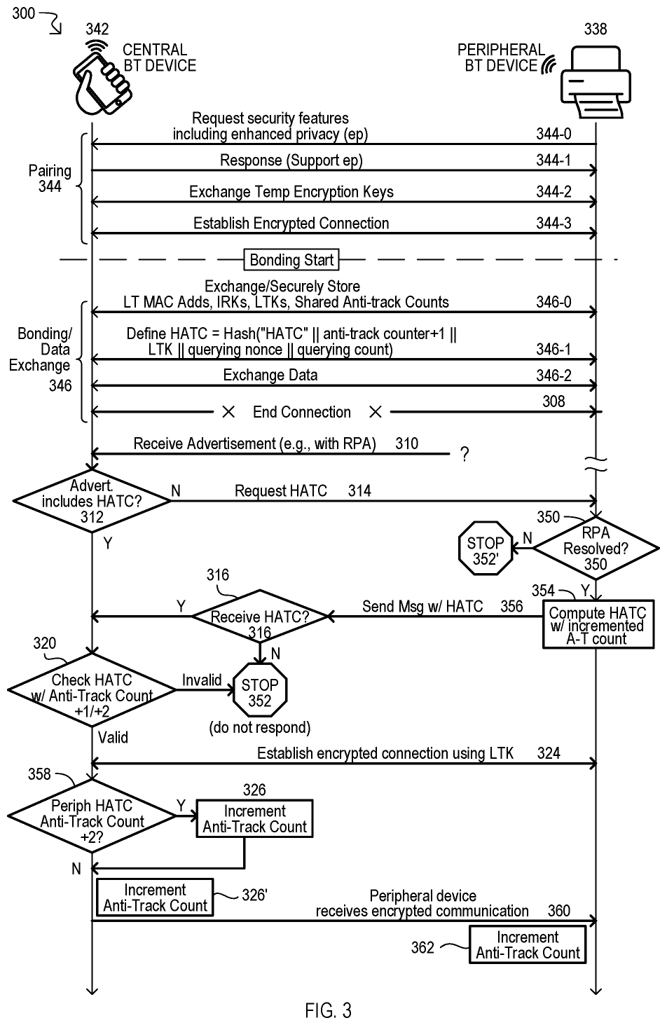

While embodiments, can operate with any suitable wireless protocol, some embodiments can include devices compatible with one or more Bluetooth (BT) standards (which are understood to include Bluetooth Low Energy, BLE). FIG. 3 shows a system 300 (and corresponding method) with BT devices according to an embodiment. A system 300 can include a BT central device 342 and a BT peripheral device 338. Central and peripheral devices 342/338 can be peer BT devices that can communicate directly with one another according to one or more BT standards.

Central and peripheral devices 342/338 can initially perform a pairing operation 344 that includes establishing an initial encrypted connection to enable the transfer of secure data (e.g., keys). A pairing operation 344 can take any suitable form, and in the embodiment of FIG. 3 can include a peripheral device 338 requesting security features, including if a central device supports enhanced privacy (ep) 344-0. Enhanced privacy can include any of the techniques described herein or equivalents, detecting replay attacks and not respond to such an attack by using a changing A-T count. In response to the request 344-0, a responding device 342 can generate response indicating that is supports ep 344-1. Central and peripheral devices 342/338 can establish or exchange temporary encryption keys 344-2. Using such the temporary encryption keys, central/responding 342/338 can establish an encrypted connection 344-3.

With an encrypted connection established, central/peripheral devices 342/338 can execute a bonding operation 346. Such an operation can include exchanging (or establishing) long term connection values, and securely storing such values 346-0. Long term connection values can include but are not limited to: long term media access control (MAC) addresses, identity resolving keys (IRKs), LTKs and a shared A-T count value. With a bonded connection, central/peripheral devices 342/338 can exchange data 346-2.

An encrypted connection between the devices can be ended 308. Such an action can include, but is not limited to, either device ending the connection, or external circumstances resulting in the ending of the connection. A central device 342 can receive an advertisement 310 that appears to be from a peripheral device. In some embodiments, this can include receiving a communication with resolvable private address (RPA), and resolving such an address with a stored IRK corresponding to a peer. A received advertisement can be checked for an HATC 312. In some embodiments, this can include determining a type of advertisement, and examining predetermined data fields. Said in another way, some advertisements may include one or more HATCs, while others may not.

If a detected advertisement does not have an HATC, a method 300 can include requesting an HATC 314. Such an action can include generating a response addressed to the peripheral device. In some embodiments, such an address can include an RPA for central device 342. A peripheral device 338 can confirm an identity of an HATC request from central device 350. In some embodiments, this can include resolving an RPA with a stored IDK for the central device 342. If the HATC request is not verified (N from 350), a method 300 can stop 352′, or in some embodiments connection can be sought with an alternate protocol (e.g., bonding). If the HATC request is verified (Y from 350), a peripheral device can compute an

HATC as described herein (i.e., with an incremented A-T count), and then transmit a message to the central device that includes the computed HATC 356. If a central device never receives an HATC after a request (N from 316), a central device may stop communications 352 with no further responses. If a central device receives an HATC in an advertisement (Y from 312) and/or receives a requested HATC (Y from 316), the received HATC can be authenticated with changed A-T counts that are incremented by one and incremented by two 320. In some embodiments, such an action can include generating two HATCs according to the accepted definition, and determining if the received HATC matches either. If a received HATC fails authentication (Invalid from 320), a central device may stop communications 352 with no further responses. Such an action can defeat a replay attack without revealing the presence of the central device 342. If a received HATC is authenticated (Valid from 320), an encrypted communication can be re-established with the peripheral device using LTKs previously received and stored in a bonding operation 324. If a received HATC was authenticated using an A-T count incremented by two (Y from 358), a central device's A-T count can be incremented 326. If a received HATC was not authenticated using an A-T count incremented by two (N from 358), or the A-T count was incremented due to a verification corresponding to A-T+2 (326), a central device's A-T count can be incremented 326′. Such an action can account A-T counts that may vary due to connections being lost.

After an encrypted communication is received from the central device over the re-established connection 360, the peripheral device 338 can increment it's A-T count 362.

In this way, BT systems can include a hashed anti-tracking count that can be generated with an anti-tracking count that can be incremented with each connection event between bonded pairs.

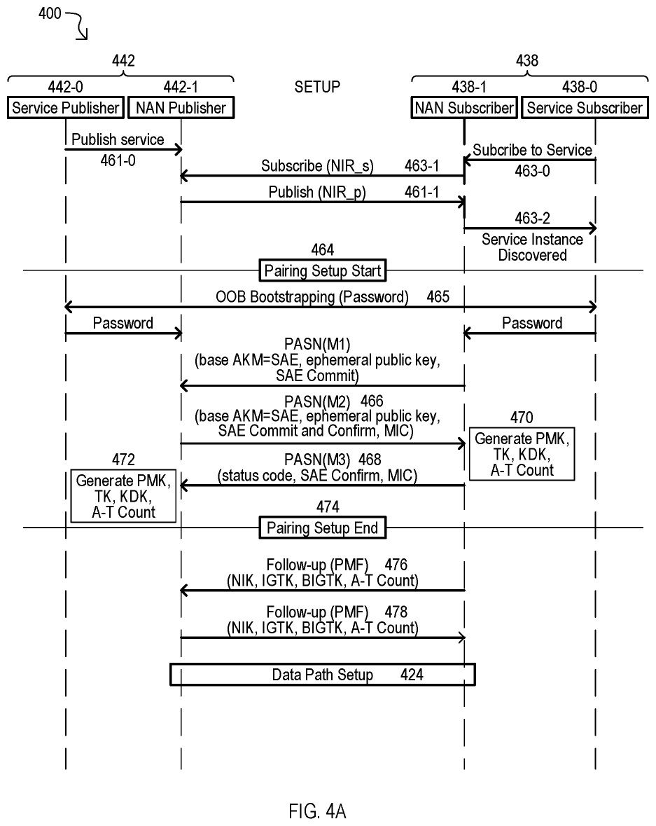

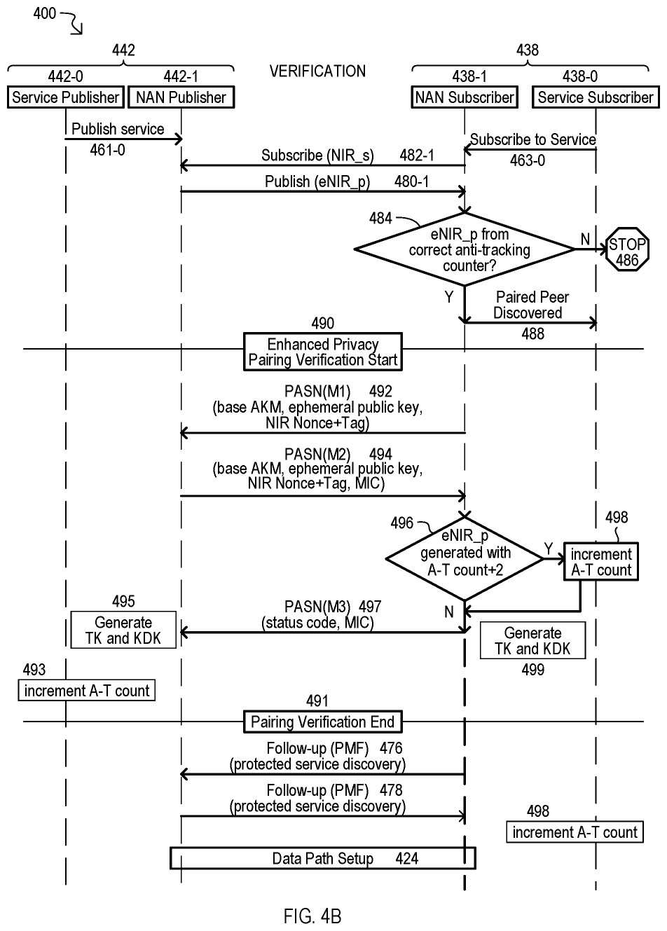

FIGS. 4A and 4B are diagrams showing how another wireless system can benefit from enhanced privacy as described herein. FIGS. 4A and 4B show a system 400 (and corresponding method) operating a neighbor aware network (NAN) with enhanced privacy. In some embodiments the NAN system can be compatible with a WiFi Aware standard. A publisher device 442 can include a service publisher 442-0 and a NAN publisher 442-1. A subscriber device 438 can include a service subscriber 438-0 and NAN subscriber 438-1.

FIG. 4A shows a pairing operation according to an embodiment. A pairing operation can include a service subscriber 438-0 subscribing to a service 463-0. In response, NAN subscriber 438-1 can generate a subscriber message that includes an NIR tag (NIR_s) 463-1. A service publisher 440-0 can publishing a service 461-0. A NAN publisher can generate a publication method that includes a NIR tag (NIR_p) 461-1. A subscriber device 438 can resolve NIR_p to discover the service instance 463-2 for the publisher device 442.

After the service instance is discovered 464, a subscriber device 438 can start a pairing setup operation 464. Such an action can include out-of-band (OOB) bootstrapping 465. This can include a password confirmation in publisher device 467-0, and a password confirmation in subscriber device 467-1. A subscriber device 438 can send a first pre-association security negotiation message (PASN(M1)) 475. In response, a publisher device 442 can return a second PASN message (PASN(M2)) 466. A subscriber device 438 can end the security negotiation with a third PASN message (PASN(M3)) 468.

PASN messaging can result in the generation of a pairwise master key (PMK), temporary key (TK) and key distribution key (KDK). Unlike conventional operations, PASN messaging can also establish the A-T count for the subscriber-publisher pair 438/442.

After a pairing setup has ended 474, in some embodiments publisher/subscriber devices 442/438 can have follow-up communications that can exchange, establish or confirm security values (e.g., A-T count). In the embodiment of FIG. 4A, follow up protected management frames (PMFs) 476/478 can result in establishing security values.

A data path can then be setup 424 to enable communications between the publisher device 442 and subscriber device 438.

FIG. 4B shows a system 400 (and corresponding method) for a pairing verification operation according to an embodiment. Such an operation can take place after devices have undergone a pairing setup operation like that shown in FIG. 4A. A subscriber device 438 can include a service subscriber 438-0 subscribing to a service 482-0, and issuing an initial subscribing message 482-1. Such a message can include a NAN tag (NIR_s). A publisher device 442 can include a service publisher 442-0 publishing a service 480-0. In response to subscription message 482-1, publisher device 442 can look up NIK values in an NIK table to try to identify NIR_s (i.e., authenticate the subscriber device 438), with a hash function as follows:

NIR_s=Truncate-64(HMAC-SHA-256(NIK_s, “NIR”, NMI_s∥Nonce_s∥counter_s)),

where NIK_s is one of the NIK values; “NIR” is a string value (which can be NIR), NMI_s is a NAN management interface address corresponding to NIK_s, Nonce_s is a nonce value corresponding to NIK_s, and counter_s is a counter value (not an A-T count) for NIK_s. In some embodiments a hash function can be the HMAC-SHA-256 hash function. Truncate-64 can be a 64-bit truncation of the value.

If a publisher device 442 resolves the received NIR_s value, it can retrieve and A-T count for the subscriber device 438 (which in some embodiments can be stored with the NIK_s value). A publisher device 442 can publish a message 480-1 with an enhanced privacy identity resolving value with a hash function as follows:

eNIR_p=Truncate-64(HMAC-SHA-256(NIK_p, “NIR”, NMI_p∥Nonce_p∥counter_p II A-T count_sp+1)),

where NIK_p is for the publisher device 442; “NIR” is a string value, NMI_p is a NAN management interface address corresponding to NIK_p, Nonce_p is a nonce value corresponding to NIK_p, and counter_p is a counter value for NIK_p, and A-T count_sp can be an A-T count for the subscriber-publisher connections. An eNIR value is understood to be one version of an HATC.

A subscriber device 438 can receive the publication with eNIR_p, and see if such a value can be resolved against stored NIKs and their corresponding A-T counts 484. In some embodiments, this can include determining if a received eNIR_p satisfies either:

eNIR_p=Truncate-64(HMAC-SHA-256(NIK_p, “NIR”, NMI_p∥Nonce_p∥counter_p∥A-T count_sp+1)) or

eNIR_p=Truncate-64(HMAC-SHA-256(NIK_p, “NIR”, NMI_p∥Nonce_p∥counter_p∥A-T count_sp+2)),

where NIK_p and A-T count_sp are corresponding values that yield a match.

If a received eNIR_p cannot be resolved (N from 484) (e.g., neither of the above condition is satisfied), the subscriber device 438 can silently abort the connection to prevent tracking with follow-on communications. If a received eNIR_p can be resolved (Y from 484) (e.g., one of the above conditions is satisfied), the paired peer can be discovered 488 and the devices can start an enhanced privacy pair verification operation 490.

In an enhanced privacy pair verification operation, a subscriber device 438 can send a PASN(M1) 492 to the service publishing device 442. The publishing device 442 can respond with a PASN M2 494 to the subscriber device 438. A subscriber device 438 can check a received PASN M2 to verify the publisher device 442 possesses a shared key established during a previous pairing setup process. If PASN M2 is validated, a subscriber device 438 can increment its A-T count 498 if it was determined (in 484) that the eNIR_p was generated with an A-T count+2 value (Y from 496). A subscriber device 438 can generate a TK and KDK, and return a PASN M3 499.

A publisher device 442 can check a received PASN M3 to verify the subscriber device 438 possesses a shared key established during a previous pairing setup process. If PASN M3 is validated, the publisher device can generate a TK and KDK 495. In addition, it can increment its stored A-T count 493. A pair verification operation can be considered to be ended 491.

Publisher device 442 and subscriber device 438 can exchange encrypted data. In FIG. 4B such an action can include a subscriber device 438 sending a PMF 476, and publisher device 442 sending a PMF 487. After receiving some encrypted data from the publisher device 442 correctly, the subscriber device 438 can increment its A-T count value 498. The incremented A-T count can replace that stored in a NIK table, which can be stored in a non-volatile memory.

It is noted that if the connection is broken or if for any reason (such as sudden crash) a subscriber device 438 may not be able to increment its A-T count (498). This can result in a publisher device's A-T count being larger than that of the subscriber device. However, through action 484, such a discrepancy can be accounted for in resolving eNIR_p and a count value can be corrected with incrementing step 498. A data path can be set up 424. In this way, NAN systems can include an enhanced privacy NIR that can include a count value that can be used to defeat replay attacks aimed as eliciting a response.

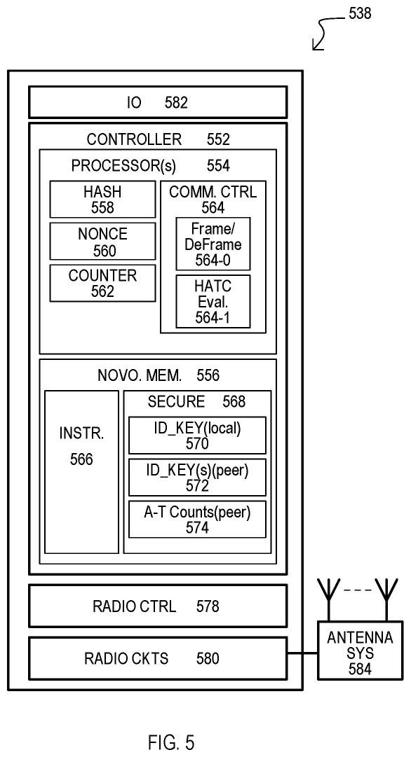

FIG. 5 is a block diagram of a device 538 according to an embodiment. Device 538 can be a central/peripheral or a publisher/subscriber device as described for embodiments herein and equivalents. A device 538 can include a controller 552, radio control circuits 578, radio circuits 580 and input/output (10) circuits 582. A controller 552 can include a processor section 554 and nonvolatile memory 556. A processor section 554 can include circuits for executing various functions descried herein, including but are not limited to: one or more processors with corresponding memory, custom logic, programmable logic, or combinations thereof. In some embodiments, a processor section 544 can execute instructions 566 stored in nonvolatile memory 556.

In the embodiment shown, a processor section 554 can provide one or more hash functions 558, one or more nonce value generators 560, and a counter circuit 562. Hash function(s) 558 can be hash functions determined by a predetermined standard and/or communication/negotiation between peer devices. Hash function(s) 558 can be used to generate a hash with varying A-T count values as described herein and equivalents (e.g., A-T count+1/+2). Such a hash can be included in a message to re-establish communications with a previously bonded/paired device, using previously exchanged/established security values (e.g., LTKs). In some embodiments, to generate the hash, a hash function 558 can operate on a number of values, including but not limited to: a key and changed A-T count value, as described herein and equivalents. Nonce value generator(s) 560 can generate nonce values for use by device 538, including for use in generating hash values and described herein. A counter circuit 562 can update an A-T count value that varies each time a connection is made or reestablished with a peer device. An A-T count updated by counter circuits 562 can be stored in nonvolatile manner. An A-T count can be used in the generation of hash values and to defeat replay attacks as described herein.

A processor section 554 can also execute communication control operations 564. Communication control operations 564 can include, but are not limited to, framing/de-framing circuits 564-0 and an HATC evaluation function 564-1. Framing/de-framing circuits 564-0 can compose data frames for transmission to peer devices, including generating fields that include an ID value formed by the concatenation of hash with other values (e.g., any of a count, a nonce or a string). HATC evaluation function 564-1 can include circuits configured to compare a received HATC value, with generated HATC values. In some embodiments, this can include comparing a received HATC with a first HATC generated with an A-T count +1, and with a second HATC generated with an A-T count +2.

Nonvolatile memory 556 can include instructions 566 and one or more secure storage regions 568. Instructions 566 can include instructions executable by processor section 554 to perform any or all operations described herein. In some embodiments, all or a portion of instructions 566 can be firmware and/or stored in secure nonvolatile memory. Secure storage regions 568 can store a local ID key for the device 538 as well as ID keys 572 and A-T counts 574 for any peers with which security/privacy data has been exchanged.

Radio control circuits 578 can control how peer communications are transmitted. Radio control circuits 578 can operate according to any suitable wireless standard or protocol that can generate packets that include HATC values as described herein or equivalents. IO circuits 582 can enable control of device 538 from sources external to the device 538. IO circuits 582 can enable communication with the device according to any suitable fashion. In some embodiments, 10 circuits 538 can include serial communication circuits, including but not limited to: serial digital interface (SDI), universal serial bus (USB), universal asynchronous receiver transmitter (UART), I²C, or I²S.

A device 538 can be connected to an antenna system 584. An antenna system 584 can include one or more antennas for transmitting and receiving wireless signals, as well as switches for enabling and disabling connections to such antennas.

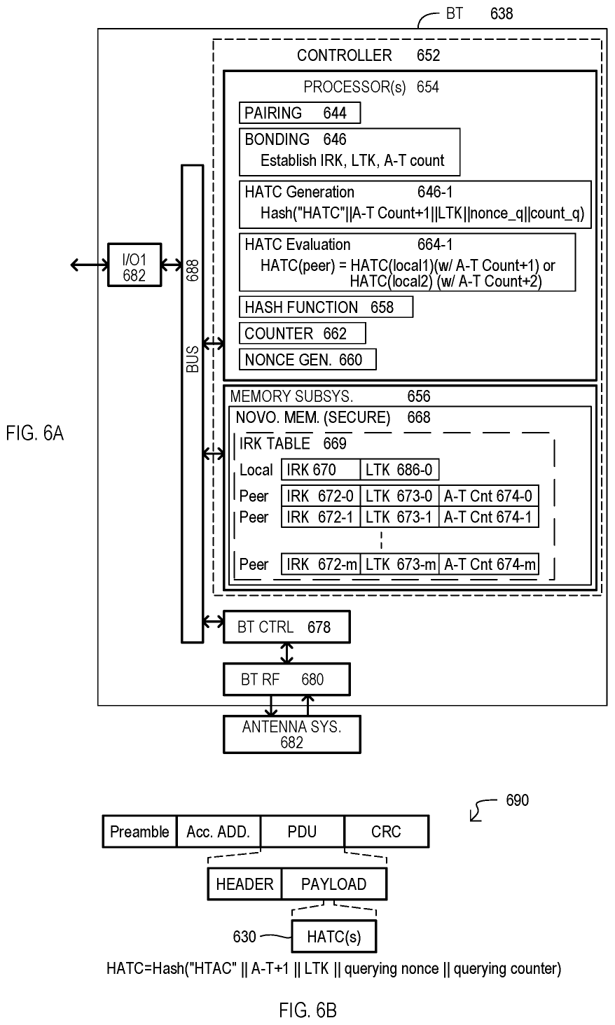

FIG. 6A shows a BT device 638 according to an embodiment. A BT device 638 can be a central or peripheral device as described herein. BT device 638 can include a controller 652, BT control circuit 678, BT radio frequency (RF) circuit 680, and 10 circuits 682 in communication with one another with a bus 688. A controller 652 can include a processor subsystem 654 and a memory subsystem 656.

A processor subsystem 654 can include one or more processors configured to execute instructions for various operations of the device. Such operations can include, but are not limited to: pairing 644, enhanced privacy bonding 646, HATC generation 646-1, HATC evaluation 664-1, one or more hash functions 658, a counter 662, and a nonce generator 660. Pairing 644 can include executing pairing operations according to one or more BT standards. Bonding 646 can include bonding according to one or more BT standards, but further include establishing an A-T count value for each peer. An A-T count value can be incremented when connections are re-established between BT peers, as described herein.

HATC generation 646-1 can generate an HATC value for BT communications, as described herein or an equivalent. In the embodiment shown, an HATC value can be generated by

HATC=Hash(“HTAC”∥A-T Count+i∥LTK∥nonce_q∥count_q)

where Hash is a hash function; “HTAC” is a string value; A-T Count+i is an A-T count incremented by one or two; nonce_q is a nonce value of a device receiving the HATO; and count_q is a count value (which is not an A-T count).

HATC evaluation 664-1 can include a device 638 generating two local HATC values, one with an A-T count incremented by one (HATC(local1)) and one with an HATC value incremented by two (HATC(local2)). The two local values can be compared to a received HATC value (HATC(peer)). If there is a match, the peer device can be authenticated as a previously bonded device. Further, from a match it can be determined whether the A-T count of the peer device matches that of device 638 (HATC(peer)=HATCH(local1), or if the A-T count of the peer device is currently one less than that of the device 638 (HATC(peer)=HATC(local2). A hash function 658 can include one or more BT hash functions, including an address hash function (ah). A counter 662 can increment an A-T count when a device 638 establishes a connection with a peer. Nonce generator 660 can generate nonce values for use with the generation of HATCs.

Memory subsystem 656 can include any suitable memory circuit types, including nonvolatile and/or volatile memory. A memory subsystem 656 can store any suitable data for the operation of the device 638, including instructions executable by processor subsystem 654 to provide the various operations described. A memory subsystem 656 can also include a secure nonvolatile memory 668 which can store various values related to security and privacy. In the embodiment shown, a secure nonvolatile memory 668 can include an IRK table 669. An IRK table 669 can include local values for the device 638, including a local IRK 670 and a local LTK 686-0. In addition, there can be entries for each peer, including an IRK 672-i, LTK 673-i and A-T count 674-l (where i corresponds to a particular entry). BT control circuits 678 can enable communications according to one or more

BT standards, including BLE. BT control circuits 678 can format and packetize data for transmission by BT circuits, as well as de-packetize received packets. This can include any of: generating advertising packets with HATCs for each bonded peer, or generating a response packet for a peer that includes an HATC for the peer.

BT RF circuit 680 can include radio circuits compatible with one or more BT standards, including receiving and transmitting packets according to a BT standard. IO circuits 682 can enable communication with between device 638 and a peer BT device.

A device 638 can operate in conjunction with an antenna system 982, which can be compatible with one or more BT standards.

FIG. 6B is a diagram showing an enhanced privacy packet 690 that can be transmitted according to an embodiment. A packet 690 can include a preamble, access address, protocol data unit (PDU), and cyclic redundancy check (CRC). A PDU can include a header portion and payload. A payload can include one or more HATCs 630, as described herein, or an equivalent.

In this way, BT systems can be provided with enhanced privacy capabilities to detect replay attacks with the inclusion of an HATC in a message to a peer.

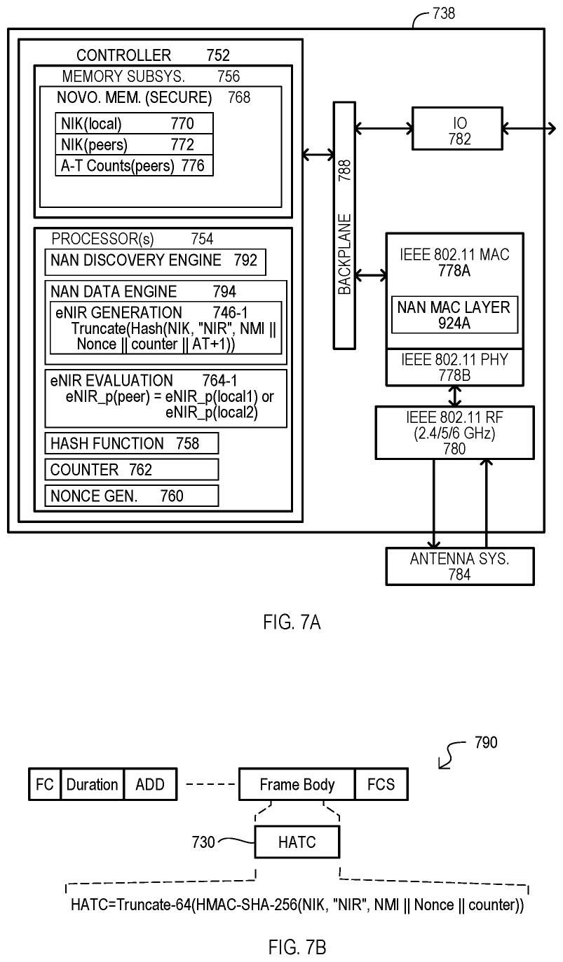

FIG. 7A show a device 738 according to another embodiment. A device 738 can be compatible with a WiFi Aware standard. A device 738 can be a publisher device or a subscriber device as described herein. Device 738 can include a controller 752, IEEE 802.11 media access control layer (MAC) circuits 778A, IEEE 802.11 physical layer (PHY) circuits 778B, IEEE 802.11 RF circuits 780, and IO circuits 782 connected to one another via a backplane 788. A controller 752 can include a memory subsystem 756 and processor subsystem 754, which can include any suitable circuits as described herein or equivalents. In the embodiment shown, a device 838 can establish protected data paths and/or data links with other peer devices that can include enhanced privacy.

Memory subsystem 756 can include any suitable memory circuit types, including nonvolatile and/or volatile memory. A memory subsystem 756 can store any suitable data for the operation of the device 738, including instructions executable by processor subsystem 754 to provide the various operations described. A memory subsystem 756 can include a secure nonvolatile memory 768 which can store various values related to security and privacy. Such values can include, but are not limited to: a local NIK 770, one or more peer NIKs 772, and one or more peer counts 776.

Processor subsystem 754 can include one or more processors configured to execute instructions for various operations of the device. A NAN discovery engine 792 can detect NAN devices/services according to a predetermined standard, including a WiFi Aware standard. A NAN data engine 794 can generate communications for setting up data paths/links with other peer devices. In the embodiment shown, a NAN data engine 794 can execute eNIR generation operations 746-1 and eNIR evaluation operations 716. eNIR generation operations 746-1 can generate an eNIR for WiFi Aware data paths/links, as described herein or an equivalent. An eNIR evaluation operation 716 can resolve a received peer eNIR and can compare it to two local eNIRs, one generated with A-T Count+1, the other generate with A-T Count+2. From such an operation, a device 738 can determine if a peer A-T count is equal to or less than the stored A-T count, as descried herein.

A hash function 758 can include one or more hash functions, and in some embodiments, can include hash functions indicated by the WiFi Aware standard (e.g., HMAC-SHA-256). A counter 762 can increment an A-T count when a device 738 re-establishes a connection with a peer. Nonce generator 760 can generate nonce values for use with eNIRs.

MAC circuits 778A can be compatible with one or more IEEE 802.11 wireless standards, and can include NAN MAC layer 924A which can include MAC functionality that can be particular to one or more NAN protocols being used. PHY circuits 778 can be compatible with one or more IEEE 802.11 wireless standards, including but not limited to IEEE 802.11n and 802.11ac. RF circuit 780 can include radio circuits compatible with one or more IEEE 802.11 wireless standards, and transmit and receive on any of 2.5 GHz, 5 GHz or 6 GHz bands. IO circuits 782 can enable communication with device 738 according to any of the embodiments herein or equivalents.

A device 738 can be connected to an antenna system 784 that can receive and transmit signals compatible with one or more IEEE 802.11 wireless standards. FIG. 7B is a diagram showing a packet 790 that can be transmitted and received by a device 738 according to an embodiment. Packet 790 can be compatible with an IEEE wireless standard. In the embodiment shown, packet 790 can include a frame control field, duration field, address fields, a frame body, and a frame check sequence. A frame body can include one or more HATCs, as described herein.

In this way a NAN device can include a NIR(ep) which can identify a peer and defeat replay attacks aimed at reusing a NIR in a replay attack.

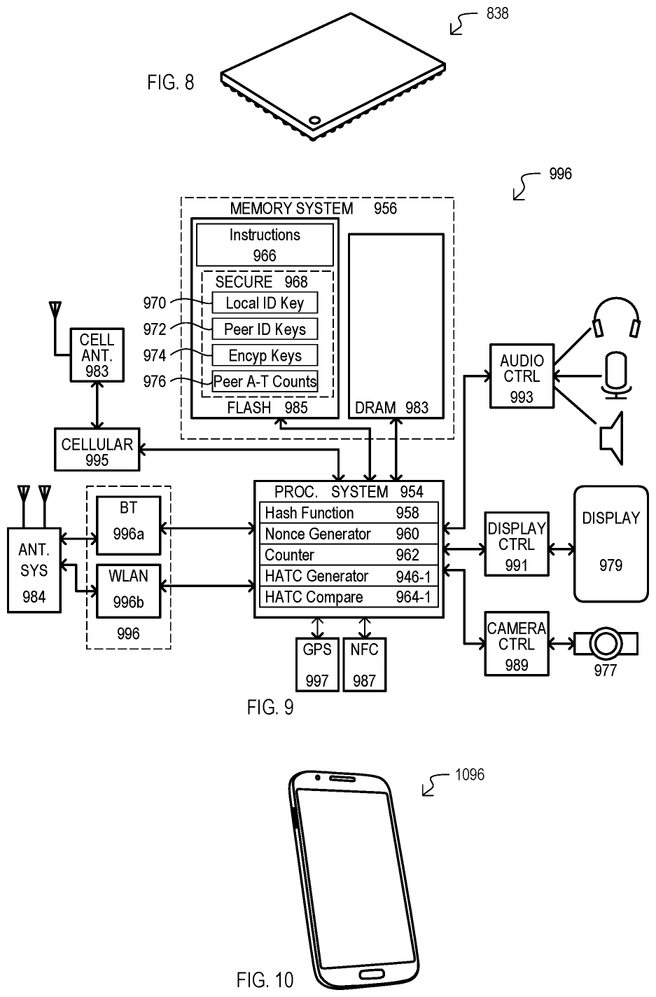

While embodiments can include devices and systems with various interconnected components, embodiments can also include unitary devices which can be provide enhanced privacy through the generation and use of HATCs as described herein. In some embodiments, such unitary devices can be advantageously compact single integrated circuits (i.e., chips). FIG. 8 shows a packaged single chip device 838 according to an embodiment. A single chip device 838 can take the form of those shown in FIGS. 5, 6A or 7A, as well as a combination device that includes both BT and NAN type circuits.

However, it is understood that a device according to embodiments can include any other suitable integrated circuit packaging type, as well as direct bonding of a device chip onto a circuit board or substrate.

FIG. 9 is a block diagram of a system 996 according to another embodiment. A system 996 can include, or a peer device as described herein. A system 996 can include a processor system 954, a memory system 956, wireless circuits 996, positioning circuits 997, cellular circuits 995, audio control circuits 993, display control circuits 991, camera control circuits 989, and near field communication (NFC) circuits 987.

A processor system 954 can take the form of any of those described herein, or equivalents, and can provide various functions according to instructions 966 stored in memory system 956. Instructions 966 can include, but are not limited to, an operating system and one or more applications that employ preexisting functions available through the operating system. Functions provided by a processing system 954 can include, but not limited to, a hash function 958, nonce generator 960, counter 962, HATC generator 946-1, and HATC compare 964-1. Such functions can take the form of any of those described herein, or equivalents.

A memory system 934 can include nonvolatile “flash” memory 985 and volatile dynamic random access memory (DRAM) 983. Flash memory 985 can include a secure storage region 968 that can store various values for executing enhanced privacy as described herein or equivalents. Stored values can include, but are not limited to, a local ID key 970, peer ID keys 972, encryption keys 975 and peer A-T counts 976. Such values can take the form of any of those described herein or equivalents.

Wireless circuits 996 can include BT circuits 996a and WLAN circuits 996b. BT circuits 996a can be compatible with one or more BT standards, including BLE. WLAN circuits 996b can be compatible with one or more IEEE 80.211 wireless standards. In some embodiments, wireless circuits 996 can be part of a combination integrated circuit device. Wireless circuits 996 can be connected to an antenna system 984. Cellular circuits 995 can provide communication functions according to one or more cellular standards and can be connected to a cellular antenna system 983.

Location circuits 997 can determine a location of a system 996, and in some embodiments can include GPS circuits. NFC circuits 987 can provide NFC capabilities for the system 996. Audio control circuits 993 can provide audio functions for the system 996. Display control circuit 991 can control a display 979 of the system 996, which an also serve as a user input (e.g., a touchscreen). A camera control circuit 989 can control a camera system 977.

In some embodiments, a processor system 954, memory system 956, and wireless circuits 996 can be formed by a system-on-chip (SoC) type device. In operation, a system 996 can establish encrypted connections with peer devices according to any of its wireless capabilities. Over such a connection, ID keys, encryption keys, and A-T counts can be established. From such values, as well as other additional values (e.g., nonce, non-A-T counter values), HATC values can be generated for identifying peer devices with which security has been established (e.g., bonded devices). When a communication is received that appears to be from a peer, an HATC value can be authenticated to defeat any possible replay attack, as described herein and equivalents. That is, failure of HATC authentication can result in any further communications from the source being ignored, preventing a system 996 from being tracked with a replay attack.

In this way, handheld electronic devices can operate with improved privacy that can preventing tracking by use of replay attacks.

While system embodiments can take any suitable form, in some embodiments, a system can be a portable electronic device, such as a handheld device, or the like. FIG. 10 shows such a system 1096 according to an embodiment. A system 1096 can be one implementation of that shown in FIG. 9.

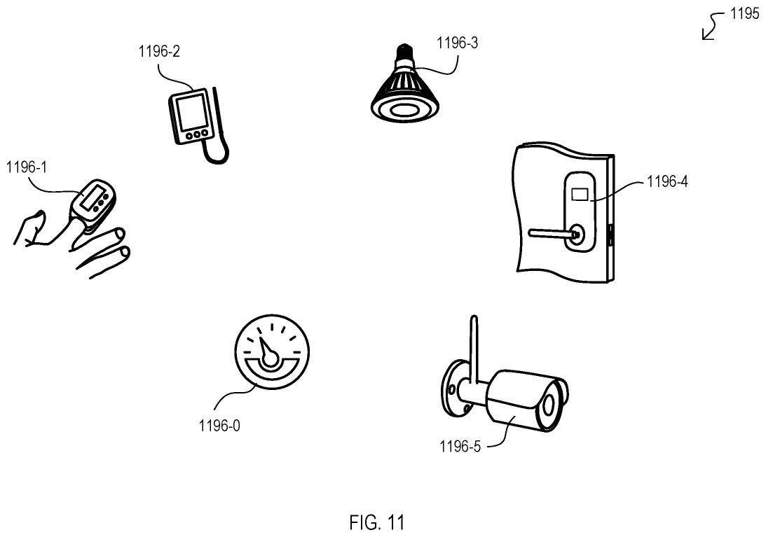

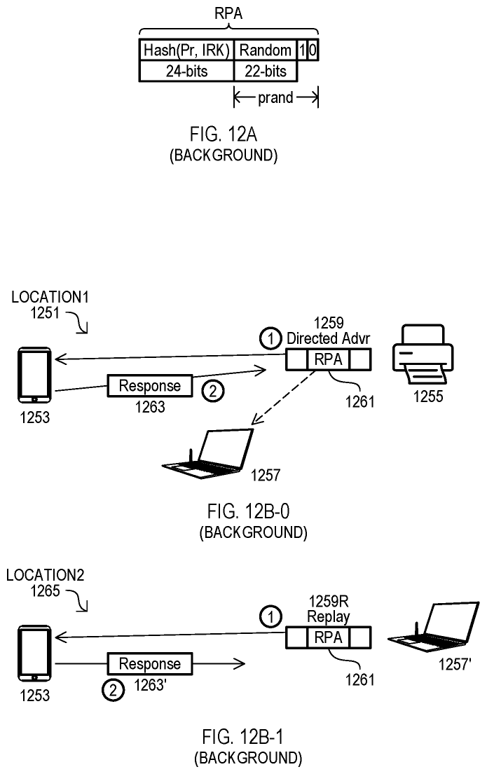

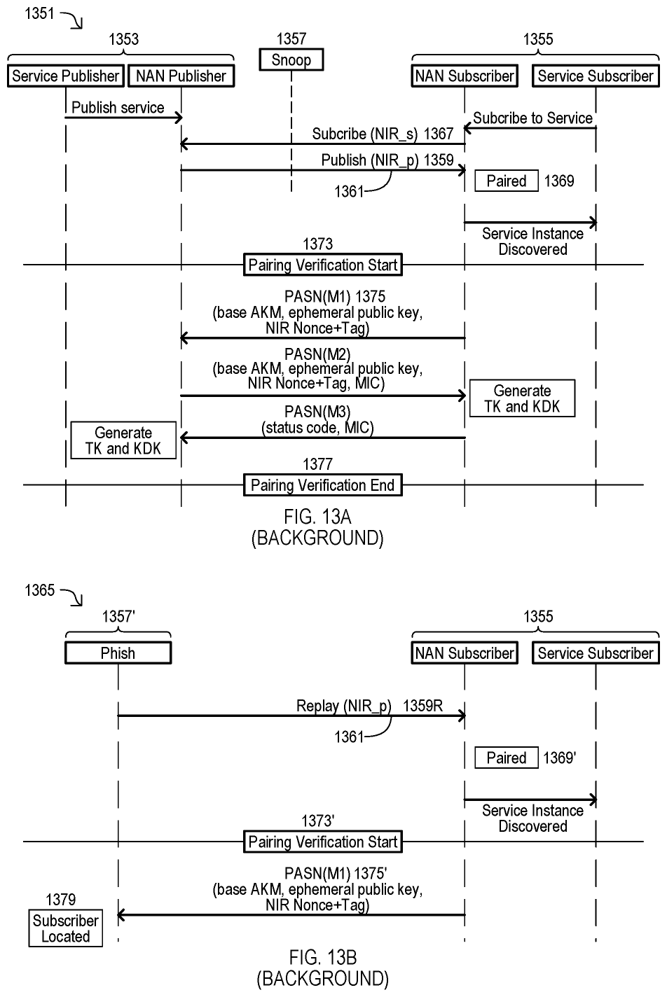

FIG. 11 shows a system 1195 according to another embodiment. A system 1195 can include various peer devices 1196-0 to -5. Peer devices (1196-0 to -5) can provide enhanced privacy as described herein. Peer devices (1196-0 to -5) can execute methods as described for FIGS. 1A to 4, include devices as shown in FIGS. 5 to 8, or include a system as shown in FIG. 9, or equivalents to any such methods, devices or systems.

In the embodiment shown, peer devices (1196-0 to -5) can be Internet-of-things (loT) type devices, such as instrumentation devices 1050-0, medical devices 1196-1/2, lighting devices 1196-3, or, security devices 1196-4/5, as but a few of many possible examples. Peer devices (1196-0 to -5) can provide for rapid connection with previously connected (e.g., bonded) devices, while at the same time ignoring replay attacks that may replay a device identity value. In this way, networks of IoT devices can have enhanced security.

Embodiments can include a method that establishes a wireless encrypted connection; establishes a LTK and an A-T count value for the peer device; and stores the LTK and A-T count value in a nonvolatile memory circuit. Communications can be received that include an identity value corresponding to the peer device and a peer HATC. At least one local HATC can be generated by executing a predetermined hash function on at least the LTK and a changed A-T count value. A changed A-T count value can be one that varies from the stored A-T count value by a predetermined amount. The received peer HATC can be authenticated with the at least one local HATC. In response to the peer HATC being authenticated, communications can occur with the peer device. In response to the peer HATC not being authenticated, the peer device can be ignored (not responded to).

Embodiments can include a device having a nonvolatile memory configured to store at least an LTK, an anti-tracking (A-T) count, and a nonce value. A device can also include a controller. A controller can be configured to establish wireless encrypted connections, receive a communication from a peer device that include an

HATC, and generate at least one local HATC by hashing at least the LTK, the peer nonce, and a changed A-T count value. A controller can further authenticate the received peer HATC with the at least one local HATC. If the peer HATC is not authenticated, communications are not made with the peer device. If the peer HATC is authenticated, communications can be made with the peer device.

Embodiments can include a system with a first wireless device that includes circuits configured to store at least a LTK, an A-T count, and a peer nonce value for a peer device. Such circuits can also establish a wireless encrypted connection with at least the LTK, receive a communication from a peer device that includes an HATC, generate at least one local HATC by hashing at least the LTK and a changed

A-T count value. The circuits can also authenticate the received peer HATC with the at least one local HATC. If the peer HATC is not authenticated, the first wireless device will not communicate with the peer device. If the peer HATC is authenticated, the first wireless can communicate with the peer device.

Methods, devices and systems according to embodiments can include generating a first local HATC with a first changed A-T count value that varies from the stored A-T count value by a first amount, and generating a second local HATC with a second changed A-T count value that varies from the stored A-T count value by a second amount. The peer HATC can be authenticated with the first and second local HATCs. In some embodiments, a first changed A-T count can be incremented by one, and a second changed A-T count can be incremented by two.

Methods, devices and systems according to embodiments can include establishing and/or re-establishing the encrypted connection compatible with at least one wireless standard selected from the group of: BT and WiFi Aware.

Methods, devices and systems according to embodiments can include a device requesting a peer HATC from what appears to be a peer device.

Methods, devices and systems according to embodiments can include, in response to the peer HATC being authenticated, re-establishing a wireless encrypted connection with the peer using at least the LTK. In response to receiving a communication from the peer over the re-established encrypted connection, the stored A-T count can be changed. In some embodiments, changing the stored A-T count can include incrementing the stored A-T count.

Methods, devices and systems according to embodiments can include a device with a nonvolatile memory and controller formed with a same integrated circuit substrate.

Methods, devices and systems can include a device with counter circuits configured to update the A-T count in the nonvolatile memory, and arithmetic logic circuits configured to execute the hash function.

Methods, devices and systems can include a device with radio circuits configured to receive and transmit packets from the peer device that are compatible with at least one wireless standard. A wireless standard can include either of a BT standard or a WiFi Aware standard.

Methods, devices and systems can include an HATC generated with a hash function executed on a string value, a changed A-T count, a LTK, a nonce, and an A-T count.

Methods, devices and systems can include a peer wireless device having peer circuits configured to store the LTK, a peer A-T count, and a peer nonce. A peer wireless device can generate a peer HATC by hashing at least the LTK, the peer nonce, the A-T count value, a nonce value, and a changed A-T count value that varies from the stored A-T count value by a predetermined amount. A peer wireless device can transmit a packet that includes the peer HATC. The peer device can also include a peer antenna system configured to transmit the request as a packet according to the at least one wireless standard.

Methods, devices and systems can include a first wireless device with circuits configured to, in response to a peer HATC being authenticated, re-establish a wireless encrypted connection with the peer with at least the LTK, and, in response to receiving a communication from the peer over the re-established encrypted connection, changing the stored A-T count. The peer wireless device can be configured to, in response to receiving a communication from the first device over the re-established encrypted connection, change its stored peer count value.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method, comprising:
establishing a wireless encrypted connection;
establishing a long term encryption key (LTK) and an anti-tracking (A-T) count value for a peer device;
storing the LTK and A-T count value in a nonvolatile memory circuit;
receiving a communication that includes an identity value corresponding to the peer device and includes a peer hashed anti-tracking count (HATC);
generating at least one local HATC by executing a predetermined hash function on at least the LTK and a changed A-T count value that varies from the stored A-T count value by a predetermined amount;
authenticating the received peer HATC with the at least one local HATC;
in response to the peer HATC being authenticated, communicating with the peer device; and
in response to the peer HATC not being authenticated, not communicating with the peer device.

2. The method of claim 1, wherein:
generating the at least one local HATC includes
generating a first local HATC with a first changed A-T count value that varies from the stored A-T count value by a first amount, and
generating a second local HATC with a second changed A-T count value that varies from the stored A-T count value by a second amount different than the first amount; and
authenticating the received peer HATC with the first local HATC or the second local HATC.

3. The method of claim 2, wherein:
the first changed A-T count value is the stored A-T count value incremented by one; and
the second changed A-T count value is the stored A-T count value incremented by two.

4. The method of claim 1, wherein establishing the encrypted connection includes establishing a connection compatible with at least one Bluetooth (BT) standard including Bluetooth Low Energy.

5. The method of claim 1, wherein establishing the encrypted connection includes establishing a connection compatible with at least one WiFi Aware standard.

6. The method of claim 1, wherein receiving the communication that includes the identity value and the peer HATC includes requesting the HATC from the peer.

7. The method of claim 1, further including:
in response to the peer HATC being authenticated, re-establishing a wireless encrypted connection with the peer with at least the LTK, and
in response to receiving a communication from the peer over the re-established encrypted connection, changing the stored A-T count.

8. The method of claim 7, wherein changing the stored A-T count includes incrementing the stored A-T count.

9. A device, comprising:
a nonvolatile memory configured to store at least a long term encryption key (LTK), an anti-tracking (A-T) count, and a nonce value; and
a controller configured to
establish wireless encrypted connections,
receive a communication from a peer device that includes a peer hashed anti-tracking count (HATC),
generate at least one local HATC by hashing at least the LTK and a changed A-T count value, the changed A-T count value varying from the stored A-T count value by a predetermined amount,
authenticate the received peer HATC with the at least one local HATC,
not communicate with the peer device if the peer HATC is not authenticated, and
communicate with the peer device if the peer HATC is authenticated.

10. The device of claim 9, wherein the nonvolatile memory and controller are formed with a same integrated circuit substrate.

11. The device of claim 9, wherein:
the controller includes
counter circuits configured to update the A-T count in the nonvolatile memory, and
arithmetic-logic circuits configured to execute a hash function for hashing at least the LTK and a changed A-T count value.

12. The device of claim 9, further including:
radio circuits configured to receive and transmit packets from the peer device that are compatible with at least one wireless standard; wherein
the at least one wireless standard is selected from the group of:
a Bluetooth standard including Bluetooth Low Energy, and a WiFi Aware standard.

13. The device of claim 9, wherein:
the controller further includes
nonce generator circuits configured to generate nonce values; and
the arithmetic logic circuits are configured to execute the hash function on at least the changed A-T count, the LTK, and the nonce value.

14. The device of claim 9, wherein:
the controller is configured to
generate a first local HATC with a first changed A-T count that is the stored A-T count value incremented by one, and
generate a second local HATC with a second changed A-T count value that is the stored A-T count value incremented by two; and
authenticating the received peer HATC with the first local HATC or the second local HATC.

15. A system, comprising:
a first wireless device that includes
circuits configured to
store at least a long term encryption key (LTK), an anti-tracking (A-T) count, and a peer nonce value for a peer device,
establish a wireless encrypted connection with at least the LTK,
receive a communication from a peer device that includes a peer hashed anti-tracking count (HATC),
generate at least one local HATC by hashing at least the LTK and a changed A-T count value that varies from the stored A-T count value by a predetermined amount,
authenticate the received peer HATC with the at least one local HATC,
not communicate with the peer device if the peer HATC is not authenticated, and
communicate with the peer if the peer HATC is authenticated; and
an antenna system configured to transmit and receive packets according to at least one wireless standard.

16. The system of claim 15, further including:
a peer wireless device that includes
peer circuits configured to
store the LTK, the peer A-T count, and the peer nonce,
generate the peer HATC by hashing at least the LTK, the peer nonce, the changed A-T count value, and
transmit a packet that includes the peer HATO; and
a peer antenna system configured to transmit the packet according to the at least one wireless standard.

17. The system of claim 16, further including:
the first wireless device circuits are further configured to
in response to the peer HATC being authenticated, re-establishing a wireless encrypted connection with at least the LTK, and
in response to receiving a communication from the peer over the re-established wireless encrypted connection, changing the stored A-T count; and
the peer wireless device is configured to, in response to receiving a communication from the first device over the re-established encrypted connection, changing its stored peer count value.

18. The system of claim 17, wherein:
the first wireless device circuits changing the stored A-T count includes incrementing the stored A-T count; and
the peer wireless device changing its stored A-T count includes incrementing its stored peer A-T count.

19. The system of claim 15, wherein:
the first wireless device circuits are configured to
generate a first local HATC with a first changed A-T count that is the stored A-T count value incremented by one, and
generate a second local HATC with a second changed A-T count value that is the stored A-T count value incremented by two; and
authenticating the received peer HATC with the first local HATC or the second local HATC.

20. The system of claim 15, wherein the wireless encrypted connections are compatible with at least one wireless standard selected from the group of: Bluetooth, including Bluetooth low energy, and WiFi Aware.
